(19) United States
(12) Patent Application Publication
(10) Pub. No.: US 2025/0372921 A1
(43) Pub. Date: Dec. 4, 2025

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Pengfei LANG, Mie (JP)

(21) Appl. No.: 18/873,335

(22) PCT Filed: May 24, 2023
(86) PCT No.: PCT/JP2023/019352

§ 371 Date: Dec. 10, 2024

(30) Foreign Application Priority Data
Jun. 13, 2022 (JP) 2022-094893

(51) Int. Cl. H01R 13/629; H01R 13/502

(52) U.S. Cl. CPC H01R 13/62944; H01R 13/502; H01R 13/62977

(57) ABSTRACT

The present invention can increase reliability of a function for holding a force boosting function member at a fitting start position. This connector comprises: a slider (30) that is provided to a first housing (11), and that fits the first housing (11) together with a second housing (61) by being relatively displaced to a fitting completion position from a fitting start position with respect to the first housing (11); a holding part (42) that is formed at the slider (30) and that has an arm-shaped locking piece (43) extending in a cantilever manner in the same direction as the displacement direction when the slider (30) is relatively displaced from the fitting start position to the fitting completion position; a stopper (16) that is formed in the first housing (11) and that restricts the movement, to the fitting completion position, of the slider (30) at the fitting start position as a result of coming into abutment with an abutment section (45) which is an extending end of the arm-shaped locking piece (43) in the same direction as the extending direction of the arm-shaped locking piece (43); and a buckling restriction part (39) that is provided to the slider (30) and that restricts buckling of the arm-shaped locking piece (43).

### TECHNICAL FIELD

The present disclosure relates to a connector.

### BACKGROUND

Patent Document 1 discloses a lever-type connector configured to exhibit a boosting function by providing a housing with a rotating lever and sliding members that move parallel to each other. When fitting the lever-type connector to a counterpart connector, flanged cam followers of the counterpart connector are fitted into cam grooves of the sliding members while the sliding members and the lever are retained at their initial positions. Then, the lever is rotated to slide the sliding members from the initial positions to fitting positions, thereby pulling the counterpart connector to the lever-type connector and fitting them to each other.

### PRIOR ART DOCUMENT

### Patent Document

Patent Document 1: JP 2006-331991 A

### SUMMARY OF THE INVENTION

### Problems to Be Solved

As a means for retaining the sliding members and the lever at the initial positions, each sliding member has an elastic arm with a shape that extends in a cantilevered manner, and an extended end portion of the elastic arm is locked to a locking recess of the housing. The elastic arm disclosed in Patent Document 1 extends in a direction opposite to the direction in which the sliding member moves when displaced from the initial position to the fitting position. Conversely, the elastic arm can alternatively have a shape that extends in a cantilevered manner in a direction identical to the moving direction of the sliding member from the initial position to the fitting position. In this case, there is concern that the elastic arm will buckle when a strong external force acts on the sliding member at the initial position in a direction toward the fitting position. The concern about buckling is not limited to cases where the elastic arm is formed on the sliding member, but also applies to cases where the elastic arm is formed on the lever.

A lever-type connector of the present disclosure was achieved based on circumstances such as those described above, and an object thereof is to improve the reliability of the function of retaining a boosting function member at its fitting start position.

### Means to Solve the Problem

A connector of the present disclosure includes: a first housing; a second housing configured to be fitted to the first housing; a boosting function member provided in the first housing and configured to be displaced from a fitting start position to a fitting completion position relative to the first housing, thereby fitting the first housing and the second housing to each other; a retaining portion formed in one member of the boosting function member and the first housing, the retaining portion including an arm-like locking piece extending in a cantilevered manner in a direction identical to a direction of displacement of the one member during the relative displacement of the boosting function member from the fitting start position to the fitting completion position; a stopper formed in the other member of the boosting function member and the first housing and configured to restrict the boosting function member at the fitting start position from moving to the fitting completion position, by an abutment portion at an extended end portion of the arm-like locking piece abutting against the stopper in a direction identical to an extending direction of the arm-like locking piece; and a buckling restriction portion provided in the boosting function member or the first housing and configured to restrict buckling of the arm-like locking piece.

### Effect of the Invention

According to the present disclosure, it is possible to improve the reliability of the function of retaining a boosting function member at its fitting start position.

### BRIEF DESCRIPTION OF THE DRAWINGS

FIG. 1 is a perspective view showing a fitted state of a connector of Embodiment 1.

FIG. 2 is a perspective view showing a first connector in an exploded state.

FIG. 3 is a perspective view of a second connector.

FIG. 4 is a perspective view of sliders.

FIG. 5 is a side view of the slider.

FIG. 6 is a side cross-sectional view showing a state before the first connector and the second connector are fitted to each other, with the slider located at a fitting start position.

FIG. 7 is a side cross-sectional view showing a state where the first connector and the second connector begin to be fitted to each other.

FIG. 8 is a side cross-sectional view showing a state where the first connector and the second connector are fitted to each other.

FIG. 9 is an enlarged horizontal cross-sectional view taken along line A-A in FIG. 6 and shows a retained state achieved by a retaining portion.

FIG. 10 is a horizontal cross-sectional view corresponding to line A-A in FIG. 6 and shows how buckling deformation of an arm-like locking piece is restricted in a retained state achieved by the retaining portion.

FIG. 11 is an enlarged horizontal cross-sectional view taken along line B-B in FIG. 7 and shows a state where retention by the retaining portion is released.

### DETAILED DESCRIPTION TO EXECUTE THE INVENTION

### Description of Embodiments of Present Disclosure

First, embodiments of the present disclosure will be listed and described.
(1) A connector of the present disclosure includes: a first housing; a second housing configured to be fitted to the first housing; a boosting function member provided in the first housing and configured to be displaced from a fitting start position to a fitting completion position relative to the first housing, thereby fitting the first housing and the second housing to each other; a retaining portion formed in one member of the boosting function member and the first housing, the retaining portion including an arm-like locking piece extending in a cantilevered manner in a direction identical to a direction of displacement of the one member during the relative displacement of the boosting function member from the fitting start position to the fitting completion position; a stopper formed in the other member of the boosting function member and the first housing and configured to restrict the boosting function member at the fitting start position from moving to the fitting completion position, by an abutment portion at an extended end portion of the arm-like locking piece abutting against the stopper in a direction identical to an extending direction of the arm-like locking piece; and a buckling restriction portion provided in the boosting function member or the first housing and configured to restrict buckling of the arm-like locking piece. With the configuration of the present disclosure, in a state where the abutment portion of the arm-like locking piece is abutting against the stopper of the other member, even when an external force acts on the boosting function member toward the fitting completion position, the buckling restriction portion prevents the arm-like locking piece from buckling. Since the arm-like locking piece is prevented from buckling, the function of retaining the boosting function member at the fitting start position is highly reliable.
(2) It is preferable that the buckling restriction portion is disposed on an opposite side of the abutment portion from the stopper. With this configuration, buckling of the arm-like locking piece is prevented by the abutment portion abutting against the buckling restriction portion.
(3) In clause (2), it is preferable that the retaining portion has a support portion in the form of a shaft extending in a direction perpendicular to the extending direction of the arm-like locking piece, the support portion connecting a base end portion of the arm-like locking piece and the one member, and the arm-like locking piece is configured to tilt in a direction that increases or decreases areas of portions of the abutment portion and the stopper that face each other, while twisting and deforming the support portion. With this configuration, stress generated in the support portion is minimized even when the tilting angle of the arm-like locking piece is increased to increase the areas of the portions of the abutment portion and the stopper that face each other.
(4) In clause (3), it is preferable that the support portion has a circular cross-sectional shape. With this configuration, when the support portion is twisted and deformed, stress can be effectively dispersed.
(5) In clause (3) or (4), it is preferable that the connector includes a movement restriction surface that faces the support portion in a direction parallel to the extending direction of the arm-like locking piece. With this configuration, when the support portion is elastically deformed so as to tilt its axis, the amount of deformation of the support portion can be suppressed by the support portion coming into contact with the movement restriction surface.
(6) In clause (3) or (4), it is preferable that the retaining portion has a releasing extension portion extending from the base end portion of the arm-like locking piece in a direction opposite to the abutment portion, the second housing has a retention release portion configured to interfere with the releasing extension portion as the second housing is fitted to the boosting function member, and interference of the retention release portion with the releasing extension portion while the abutment portion is facing the stopper causes the retaining portion to tilt and the abutment portion to displace to a position where the abutment portion does not face the stopper. With this configuration, when the second housing and the boosting function member are fitted to each other while the boosting function member is retained at the fitting start position by the retaining portion, the retention by the retaining portion is released due to interference between the retention release portion and the releasing extension portion. Therefore, manual operation to release the retention is not necessary.
(7) In clause (6), it is preferable that a separation distance from the support portion to a position of interference of the releasing extension portion with the retention release portion is smaller than a separation distance from the support portion to the abutment portion. With this configuration, at the time of release of the retention, the amount of displacement of the abutment portion is larger than the amount of displacement of the releasing extension portion, and this can ensure that the areas of the portions of the abutment portion and the stopper that face each other are large.
(8) In clause (6), it is preferable that the other member has a tilt restriction surface that faces the abutment portion from a side that is opposite to a direction of displacement of the abutment portion caused by interference between the retention release portion and the releasing extension portion. With this constitution, even when the abutting portion pressed against the stopper slips against the stopper, the abutment portion can be retained in the state of abutting against the stopper.

### DETAILS OF EMBODIMENTS OF PRESENT DISCLOSURE

### Embodiment 1

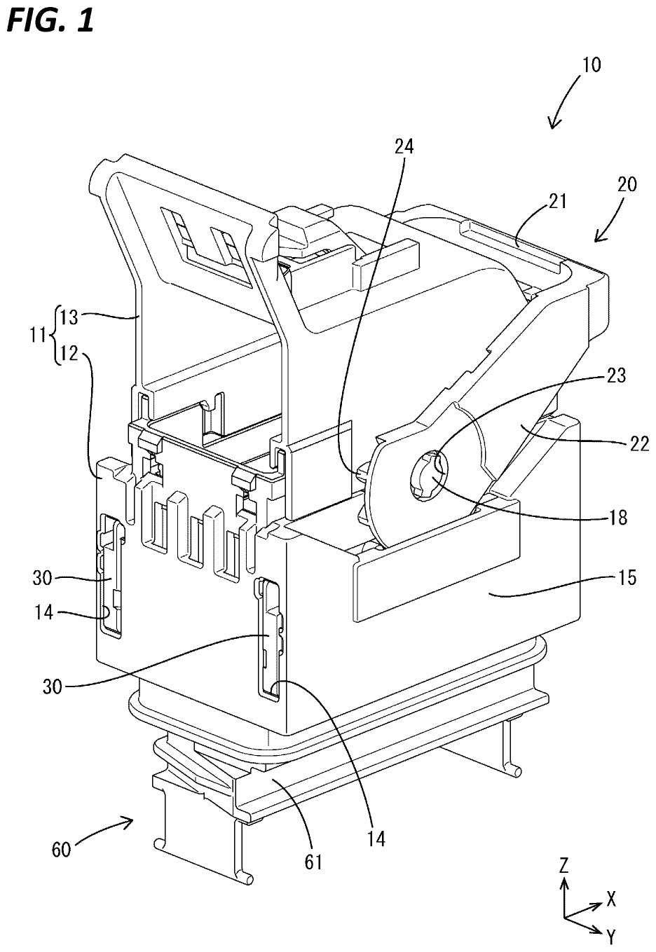

A connector of Embodiment 1 of the present disclosure will be described with reference to FIGS. 1 to 11. The present invention is not limited to examples given below, but is indicated by the claims, and all changes that come within the meaning of equivalency and the scope of the claims are included in the present invention. In Embodiment 1, with respect to a front-rear direction, the positive direction of the X-axis in FIGS. 1 to 11 is defined as a forward direction. With respect to a left-right direction, the positive direction of the Y-axis in FIGS. 1 to 4 and 9 to 11 is defined as a rightward direction. The terms “left-right direction” and “width direction” are used synonymously. With respect to an up-down direction, the positive direction of the Z-axis in FIGS. 1 to 8 is defined as an upward direction.

As shown in FIG. 1, the connector of Embodiment 1 includes a first connector 10 and a second connector 60 that can be fitted to each other. The first connector 10 has a lever 20 and a slider 30, which constitute a boosting function member. The lever 20 and the slider 30 exhibit a boosting function by cooperating with each other. The first connector 10 and the second connector 60 can be fitted to each other by applying a small operating force to the lever 20.

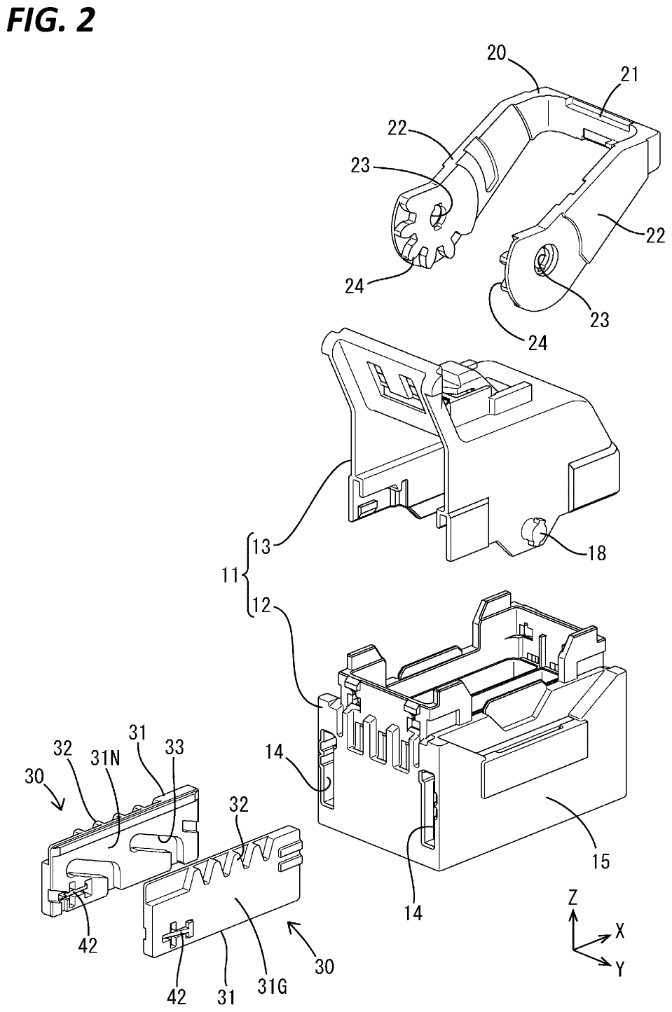

As shown in FIG. 2, the first connector 10 includes a first housing 11, a single symmetrical lever 20, and a pair of symmetrically-shaped sliders 30. The first housing 11 is constituted by a housing main body 12 made of a synthetic resin and a wire cover 13 made of a synthetic resin and attached to an upper surface of the housing main body 12. A female first terminal fitting (not shown) is inserted in the housing main body 12. A wire (not shown) connected to the first terminal fitting is led upward out of the housing main body 12, bent within the wire cover 13, and then led rearward out of the first housing 11.

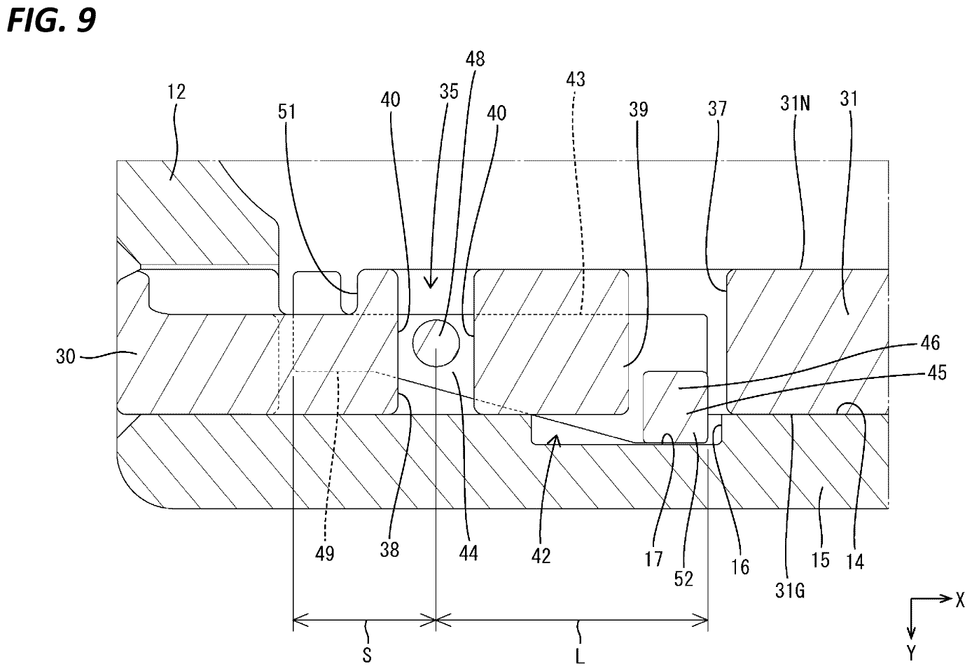

A pair of left and right guide spaces 14 extending in the front-rear direction are formed in the housing main body 12. The pair of guide spaces 14 are located along both left and right outer wall portions 15 of the housing main body 12. Front and rear ends of each guide space 14 both open in slit-like shapes elongated in the up-down direction, at both front and rear end faces of the housing main body 12. As shown in FIGS. 9 to 11, a stopper 16 and a tilt restriction surface 17 are formed in both front and rear end portions of each guide space 14 by recessing an inner surface (surface facing the guide space 14) of a corresponding outer wall portion 15. The stopper 16 faces rearward. The tilt restriction surface 17 faces the guide space 14. A front end of the tilt restriction surface 17 is connected to the stopper 16 at a right angle. A pair of shaft portions 18 are formed, one on a left outer side surface and one on a right outer side surface, respectively, of the wire cover 13.

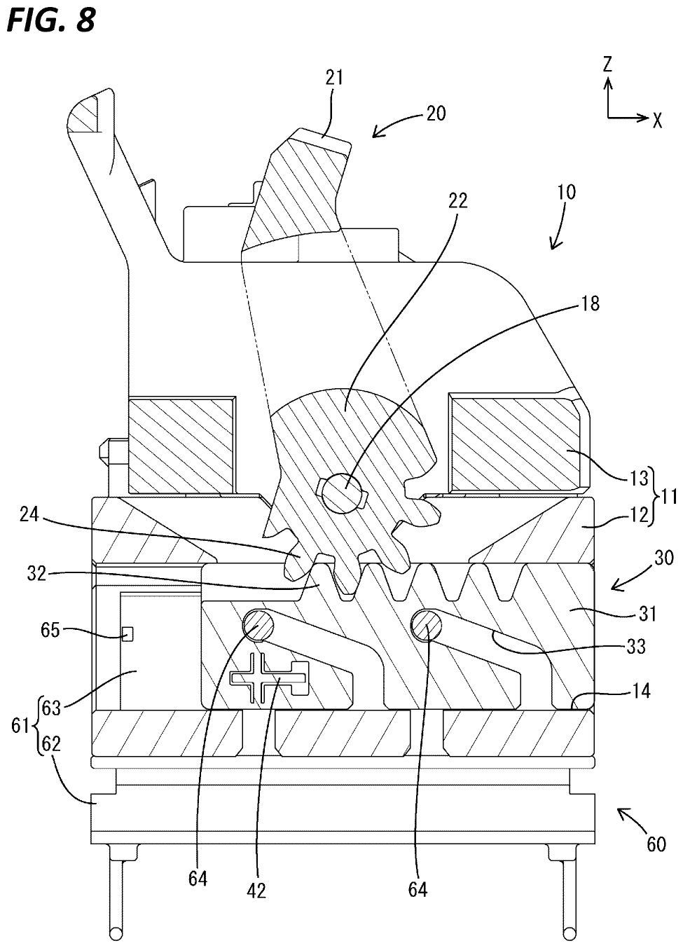

The lever 20 is a single component made of a synthetic resin and has an operating portion 21 elongated in the left-right direction and a pair of left and right arm portions 22 extending from both left and right ends of the operating portion 21, respectively. Bearing holes 23 formed in the arm portions 22 are fitted to the respective shaft portions 18 of the first housing 11. When an operating force is applied to the lever 20 by gripping the operating portion 21, the lever 20 rotates about the shaft portions 18 between a fitting start position (see FIGS. 1, 6, and 7) and a fitting completion position (see FIG. 8). In a state where the lever 20 is at the fitting start position, the operating portion 21 is located forward of the shaft portions 18. In a state where the lever 20 is at the fitting completion position, the operating portion 21 is located rearward of the shaft portions 18. Circular arc-shaped gears 24 are formed on inner surfaces of the arm portions 22, the gears being concentric with the shaft portions 18.

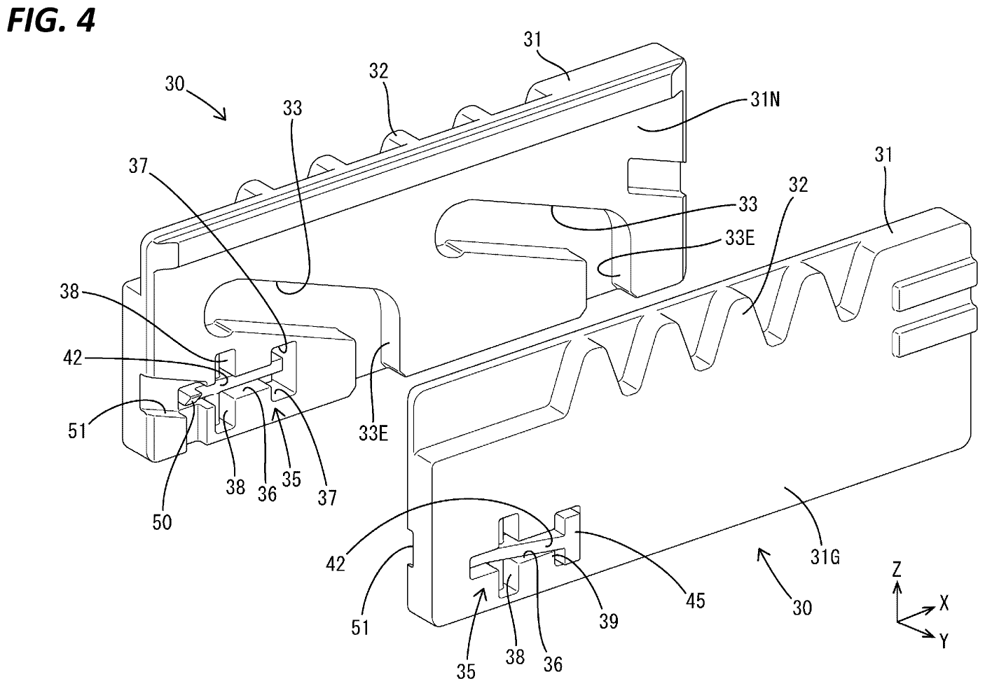

Each slider 30 is a single component made of a synthetic resin material and has a plate-shaped main body portion 31 and a retaining portion 42. As shown in FIGS. 2 and 4, the plate-shaped main body portion 31 is a rectangular plate-shaped portion with its long sides aligned with the front-rear direction. A rack 32 extending in the front-rear direction is formed at an upper end edge portion of the plate-shaped main body portion 31. Of left and right surfaces of the plate-shaped main body portion 31, the surface that opposes the other plate-shaped main body portion 31, of the two plate-shaped main body portions 31, is defined as an inner surface 31N, and the surface that does not oppose the other plate-shaped main body portion 31 is defined as an outer surface 31G. Two cam grooves 33 are formed on the inner surface 31N of the plate-shaped main body portion 31, spaced apart from each other in the front-rear direction. Inlets 33E of the cam grooves 33 open on a lower surface of the plate-shaped main body portion 31.

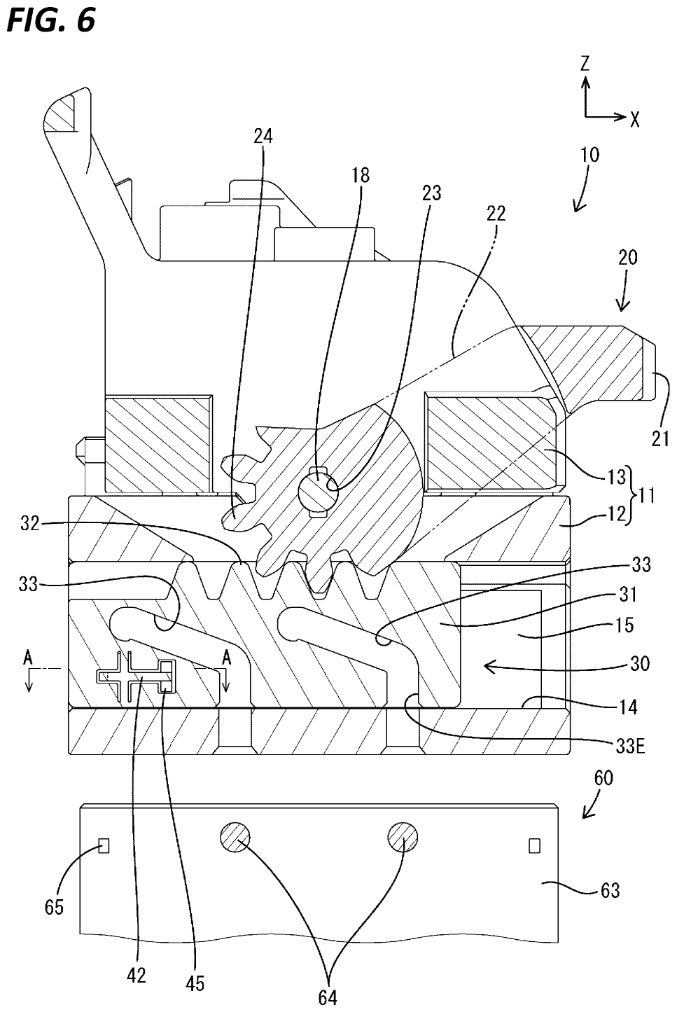

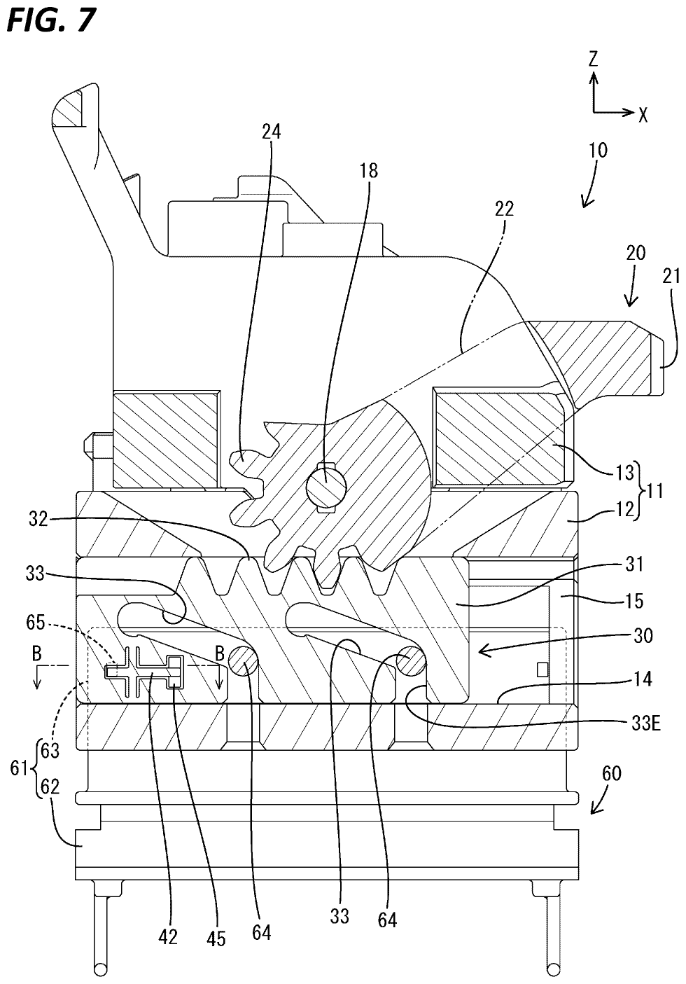

The pair of sliders 30 are attached to the housing main body 12 while being accommodated in the pair of guide spaces 14, with their plate thickness direction aligned with the left-right direction. As shown in FIGS. 6 to 8, in a state where the wire cover 13 is attached to the housing main body 12, the gears 24 of the lever 20 are each meshed with a proper location on the rack 32 of the corresponding slider 30. In a state where the lever 20 is at the fitting start position, the sliders 30 are disposed at their fitting start positions on a rear end side in the respective guide spaces 14 (see FIGS. 6 and 7). In a state where the lever 20 is at the fitting completion position, the sliders 30 are disposed at their fitting completion positions on a front end side in the respective guide spaces 14 (see FIG. 8). When the lever 20 is operated, the sliders 30 move parallel to each other between their fitting start positions and fitting completion positions in the front-rear direction. Hereinafter, the term “front-rear direction” is used synonymously with a “moving direction of the slider 30 between the fitting start position and the fitting completion position”.

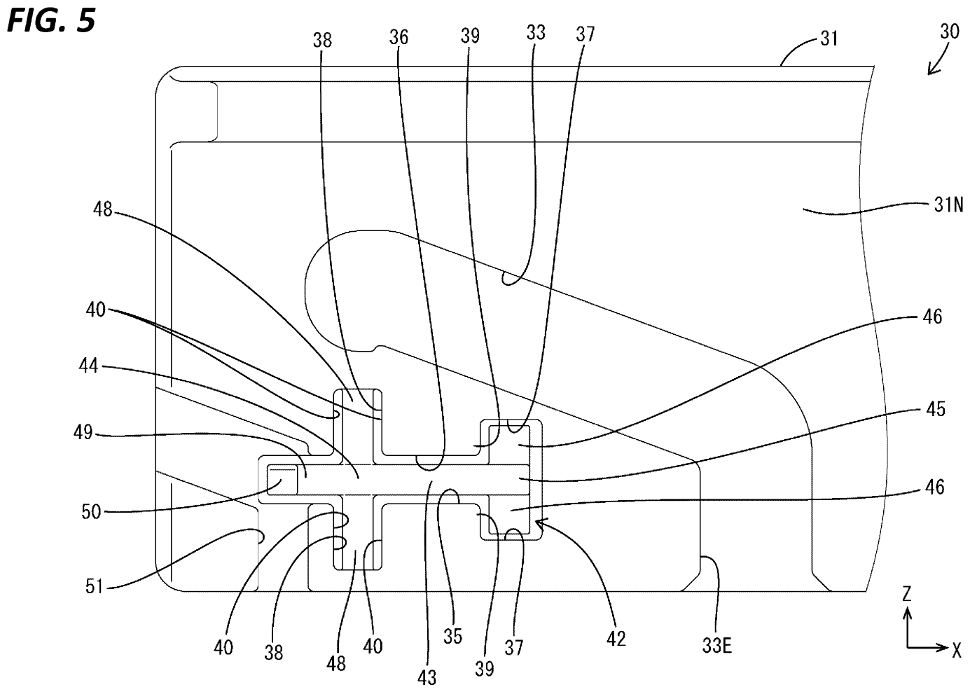

As shown in FIGS. 4 and 5, accommodation spaces 35 for accommodating the retaining portions 42 are formed in the left and right plate-shaped main body portions 31, respectively. Each accommodation space 35 opens on the inner surface 31N and the outer surface 31G of the corresponding plate-shaped main body portion 31. The accommodation space 35 is constituted by a single first groove 36, a pair of upper and lower recesses 37, and a pair of upper and lower second grooves 38. The first groove 36 is an elongated space extending in the front-rear direction. The recesses 37 are spaces that are recessed so that a front end portion of the first groove 36 is widened both upward and downward in the up-down direction. A pair of upper and lower sections of the plate-shaped main body portion 31, respectively facing the upper and lower recesses 37 from the rear, function as buckling restriction portions 39. In the front-rear direction, the buckling restriction portions 39 are disposed on the fitting start position side of the recesses 37 (i.e., rearward of the recesses 37). The second grooves 38 are spaces that are located at positions rearward of the center of the first groove 36 in the front-rear direction and extend from the first groove 36 both upward and downward in the up-down direction. Front and rear inner wall surfaces of each of the upper and lower second grooves 38 function as movement restriction surfaces 40, which individually face a support portion 48 of the retaining portion 42, which will be described later, in the front-rear direction with a clearance.

The retaining portion 42 is a portion that functions to retain the slider 30 and the lever 20 at their fitting start positions. The retaining portion 42 includes a single arm-like locking piece 43 elongated in the front-rear direction, a single abutment portion 45, a pair of upper and lower support portions 48, and a single releasing extension portion 49. The arm-like locking piece 43 has a shape extending forward in a cantilevered manner from a base end portion 44 of the retaining portion 42. The direction in which the arm-like locking piece 43 extends is identical to the moving direction of the slider 30 from the fitting start position to the fitting completion position. The base end portion 44 (rear end portion) of the arm-like locking piece 43 is the same portion as the base end portion 44 of the retaining portion 42. The arm-like locking piece 43 is accommodated in a region of the first groove 36 that communicates with the second grooves 38 and in a region of the first groove 36 that is located forward of the second grooves 38.

The abutment portion 45 is constituted by an extended end portion (front end portion) of the arm-like locking piece 43 and a pair of upper and lower widened portions 46, and has a rectangular parallelepiped shape. The widened portions 46 are portions protruding from the front end portion of the arm-like locking piece 43 in the up-down direction. Hereinafter, the term “up-down direction” is used synonymously with a “direction perpendicular to the moving direction of the slider 30 between the fitting start position and the fitting completion position”. An extended end surface (front end surface) of the arm-like locking piece 43 and front surfaces of the widened portions 46 are continuous and flush with each other and together function as a locking surface. The widened portions 46 of the abutment portion 45 are accommodated in the recesses 37. The widened portions 46 and the buckling restriction portions 39 are arranged so as to face each other in a direction identical to the moving direction of the slider 30 with a clearance. In the moving direction of the slider 30, the buckling restriction portions 39 are disposed on the fitting start position side of the widened portions 46. In other words, the buckling restriction portions 39 are disposed so as to face the abutment portion 45 from the support portion 48 side.

The pair of upper and lower support portions 48 are portions protruding from the base end portion 44 of the arm-like locking piece 43 in the up-down direction, and are respectively accommodated in the second grooves 38. Extended ends of the support portions 48 are connected to the plate-shaped main body portion 31 at an upper end or a lower end of the respective second grooves 38. The retaining portion 42 is supported on the plate-shaped main body portion 31 by the pair of support portions 48. The support portions 48 are in the form of rods with their axes aligned with the up-down direction. The support portions 48 have a circular cross-sectional shape. The support portions 48 and the movement restriction surfaces 40 are arranged so as to face each other in a direction identical to the moving direction of the slider 30 with a clearance. In the moving direction of the slider 30, the movement restriction surfaces 40 are present on the fitting start position side of the support portions 48.

The releasing extension portion 49 is a portion extending in a cantilevered manner from the base end portion 44 of the retaining portion 42 in a rearward direction, which is opposite to the arm-like locking piece 43. As shown in FIGS. 4 and 5, a pressure receiving surface 50 is formed at a rear end portion of the releasing extension portion 49, the pressure receiving surface being inclined relative to both the up-down direction and the left-right direction. The releasing extension portion 49 is accommodated in a region of the first groove 36 that is located rearward of the second grooves 38.

An interference avoidance groove 51 is formed on the inner surface 31N of the plate-shaped main body portion 31. The interference avoidance groove 51 opens at a lower end edge of the plate-shaped main body portion 31 and has the same shape as the cam grooves 33. The interference avoidance groove 51 is disposed so as to pass through a rear end portion of the first groove 36. The pressure receiving surface 50 is located in the middle of the interference avoidance groove 51. As shown in FIG. 9, in the front-rear direction, a separation distance S from the center of the support portions 48 to a rear end of the pressure receiving surface 50 is smaller than a separation distance L from the center of the support portions 48 to a front end of the abutment portion 45.

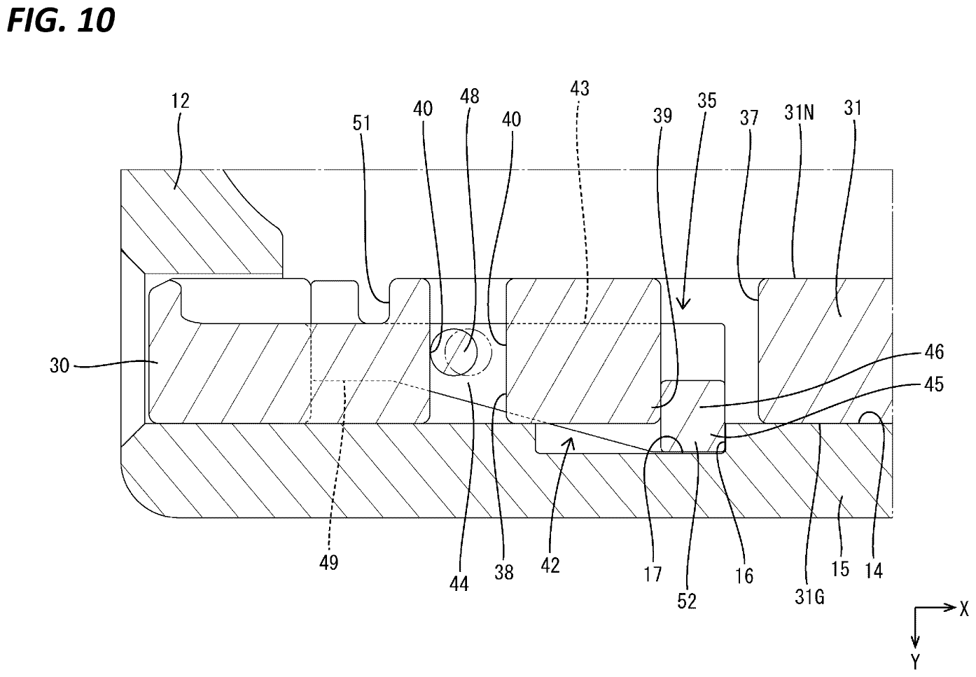

The retaining portion 42 is usually retained at a retaining position (see FIGS. 9 and 10) in a state where the retaining portion 42 can be freely displaced, due to the shape retentivity of the support portions 48. In a state where the retaining portion 42 is at the retaining position, a locking portion 52, which is an outer end portion of the abutment portion 45 in the width direction, protrudes outward in the width direction (downward in FIGS. 9 and 10) from the outer surface 31G of the plate-shaped main body portion 31. The abutment portion 45 is located so as to face the buckling restriction portions 39 from the fitting completion position side (front side).

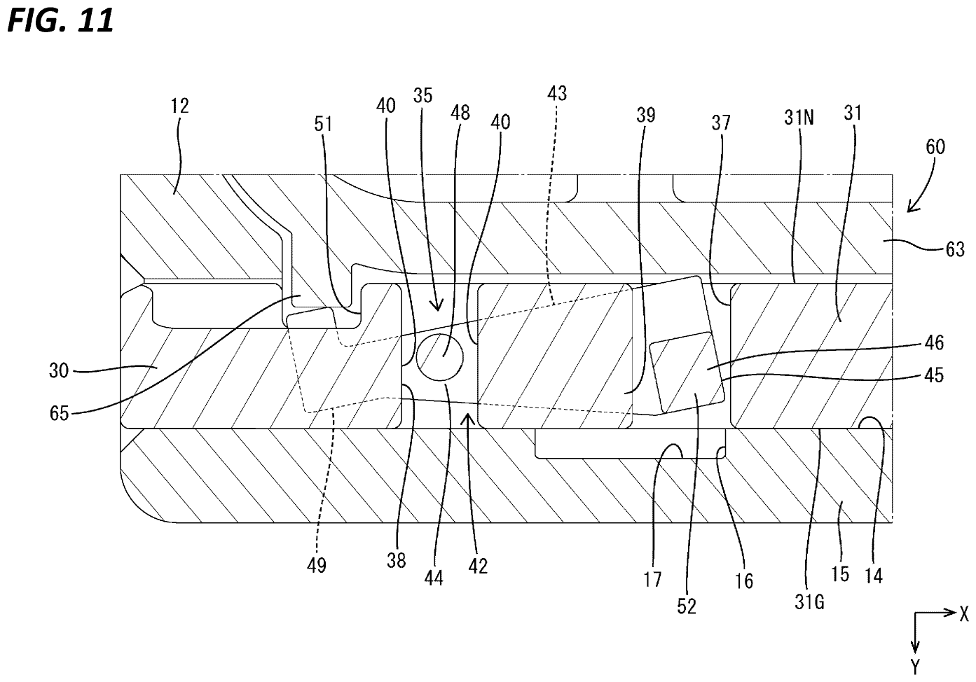

The retaining portion 42 can tilt in the left-right direction with the support portions 48 serving as a fulcrum. Hereinafter, the term “left-right direction” is used synonymously with a “direction perpendicular to the moving direction of the slider 30 between the fitting start position and the fitting completion position”. The retaining portion 42 can be displaced from the retaining position to a retention release position (see FIG. 11) while elastically twisting and deforming the support portions 48. In a state where the retaining portion 42 has been displaced to the retention release position, the entire abutment portion 45 including the locking portion 52 is accommodated in the first groove 36 and the recesses 37.

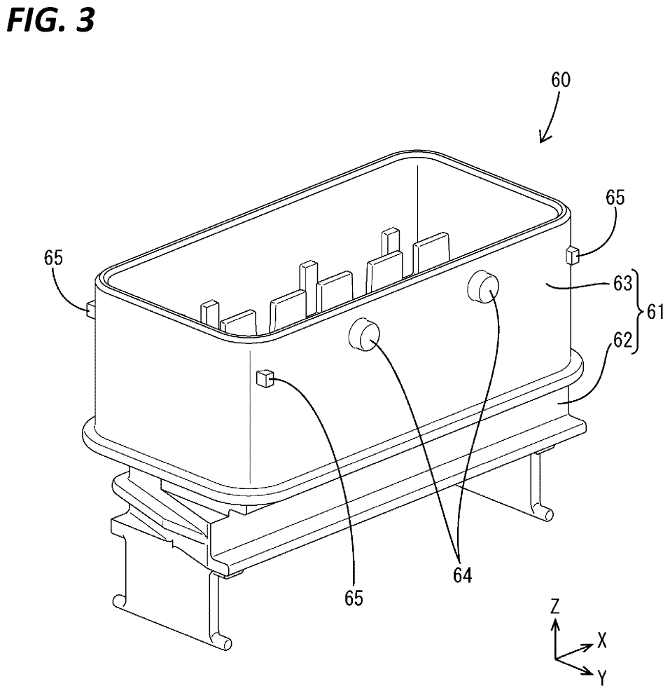

The second connector 60 is formed by assembling a second housing 61 and a plurality of male second male terminal fittings (not shown). As shown in FIG. 3, the second housing 61 is a single component having a terminal main body portion 62 and a hood portion 63 extending upward from an outer peripheral edge of an upper surface of the terminal main body portion 62. The second terminal fittings are attached to the terminal main body portion 62 and protrude into the hood portion 63. Two pairs of cam followers 64 are formed on both left and right outer side surfaces of the hood portion 63, with one pair on each outer side surface, and the cam followers 64 of each pair are spaced apart from each other in the front-rear direction. The cam followers 64 are in the form of cylindrical protrusions. Retention release portions 65 in the form of protrusions are formed on both front and rear end portions of each of the left and right outer side surfaces of the hood portion 63.

Next, a procedure for fitting the first connector 10 and the second connector 60 to each other will be described. In the first connector 10, the lever 20 and the sliders 30 are moved to their fitting start positions in advance. The sliders 30 at the fitting start positions are restricted from moving toward the fitting completion positions and retained at the fitting start positions by the retaining portions 42. FIGS. 9 to 11 show a retaining structure of the slider 30 on the right side. The retaining structure of the slider 30 on the left side is symmetrical to that of the slider 30 on the right side, and therefore, its description is omitted.

When the two connectors 10 and 60 are not fitted yet, and the slider 30 is at the fitting start position, as shown in FIG. 9, the retaining portion 42 is at the retaining position, with the locking portion 52 of the abutment portion 45 being located so as to face the stopper 16 of the first housing 11 from the rear with a clearance between them. When a moving force is applied to the slider 30 toward the fitting completion position, the locking portion 52 abuts against the stopper 16, and the movement of the slider 30 is thus restricted.

When the moving force applied to the slider 30 toward the fitting completion position is strong, then, as shown in FIG. 10, while the abutment portion 45 remains abutting against the stopper 16, the plate-shaped main body portion 31 and the extended end portions of the support portions 48, which extend from the arm-like locking piece 43, move forward relative to the abutment portion 45. Here, the abutment portion 45 is formed at the extended end portion (front end portion) of the arm-like locking piece 43, which extends from the support portions 48 toward the fitting completion position in a cantilevered manner. Therefore, there is concern that the arm-like locking piece 43 will buckle and deform between the abutment portion 45 and the support portions 48. However, when the plate-shaped main body portion 31 and the support portions 48 move slightly relative to the abutment portion 45, the buckling restriction portions 39 abut against the widened portions 46 of the abutment portion 45 from the rear, preventing the plate-shaped main body portion 31 and the support portions 48 from moving further forward relative to the abutment portion 45. Accordingly, the arm-like locking piece 43 is prevented from buckling and deforming between the abutment portion 45 and the support portions 48.

Since the locking portion 52 is disposed at a position shifted outward in the width direction relative to the support portions 48, there is concern that, when a moving force is applied to the slider 30 toward the fitting completion position, the abutment portion 45 will be displaced outward in the width direction (downward in FIGS. 9 and 10) and come off the stopper 16. However, the tilt restriction surface 17 is disposed at a position adjacent to the stopper 16 on the outer side in the width direction, and the abutment portion 45 abuts against this tilt restriction surface 17 from the inner side in the width direction. Thus, the locking portion 52 is prevented from coming off the stopper 16.

Next, with the lever 20 and the sliders 30 retained at the fitting start positions, the hood portion 63 of the second connector 60 is fitted into the housing main body 12 of the first connector 10 from below. The hood portion 63 is fitted into the housing main body 12 along the inner surfaces 31N of both the left and right plate-shaped main body portions 31 (both the left and right sliders 30), and as shown in FIG. 7, the cam followers 64 enter the inlets 33E of the cam grooves 33. In the process of the hood portion 63 entering, the retention release portions 65 move in the interference avoidance grooves 51 and press the pressure receiving surfaces 50 of the releasing extension portions 49. As shown in FIG. 11, this pressing action causes the retaining portion 42 to tilt to the retention release position with the support portions 48 serving as a fulcrum, and the abutment portion 45 (locking portion 52) is displaced to a position where it is located on the inner side in the width direction relative to the stopper 16 and is coming off the stopper 16. As a result, the slider 30 is released from the retained state where it is retained by the abutment portion 45 and the stopper 16, and can move toward the fitting completion position.

After that, the lever 20 is rotated from the fitting start position to the fitting completion position by gripping the operating portion 21 of the lever 20. As the lever 20 is operated, the sliders 30 move from the fitting start positions to the fitting completion positions, and the sliding between the cam grooves 33 and the cam followers 64 brings the first connector 10 and the second connector 60 closer to each other in the up-down direction, advancing their fitting process. As shown in FIG. 8, when the lever 20 and the sliders 30 reach the fitting completion positions, the fitting process of the first connector 10 and the second connector 60 is completed.

To separate the fitted first and second connectors 10 and 60, the lever 20 is rotated from the fitting completion position to the fitting start position. This operation causes the sliders 30 to move from the fitting completion positions to the fitting start positions, and the sliding between the cam grooves 33 and the cam followers 64 separates the first connector 10 and the second connector 60 from each other.

In a state where a slider 30 is removed from the first housing 11, if the retaining portion 42 significantly tilts outward in the width direction, and the widened portions 46 protrude outward from the outer surface 31G of the plate-shaped main body portion 31, and furthermore, if an external force acts on the retaining portion 42 in the front-rear direction, the support portions 48 deform to tilt significantly in the front-rear direction. At this time, the support portions 48 come into contact with the movement restriction surfaces 40, thereby restricting the retaining portion 42 from moving relative to the plate-shaped main body portion 31 in the front-rear direction. Thus, the support portions 48 can be prevented from being plastically deformed or broken.

The connector of Embodiment 1 includes the first housing 11, the second housing 61, which can be fitted to the first housing 11, the boosting function member (lever 20 and sliders 30) provided in the first housing 11, and the buckling restriction portions 39. The lever 20 and the sliders 30 are displaced from the fitting start positions to the fitting completion positions relative to the first housing 11, thereby fitting the first housing 11 and the second housing 61 to each other.

Each slider 30, which constitutes the boosting function member, has the retaining portion 42. The retaining portion 42 includes the arm-like locking piece 43 extending therefrom in a cantilevered manner. The direction in which the arm-like locking piece 43 extends is identical to the direction of displacement of the slider 30 when the slider 30 is relatively displaced from the fitting start position to the fitting completion position. The first housing 11 includes the stopper 16. When the abutment portion 45 at the extended end portion of the arm-like locking piece 43 abuts against the stopper 16 in a direction identical to the extending direction of the arm-like locking piece 43, the stopper 16 restricts the slider 30 at the fitting start position from moving to the fitting completion position. The slider 30 is provided with the buckling restriction portions 39, which restrict buckling of the arm-like locking piece 43.

In a state where the abutment portion 45 of the arm-like locking piece 43 is abutting against the stopper 16 of the first housing 11, even when an external force acts on the slider 30 toward the fitting completion position, the buckling restriction portions 39 prevent the arm-like locking piece 43 from buckling. The buckling restriction portions 39 are disposed on the opposite side of the abutment portion 45 from the stopper 16, in the moving direction of the slider 30. Buckling of the arm-like locking piece 43 is prevented by the abutment portion 45 abutting against the buckling restriction portions 39. Since the arm-like locking piece 43 is prevented from buckling, the function of retaining the slider 30 at the fitting start position is highly reliable.

The retaining portion 42 includes the pair of upper and lower support portions 48. The support portions 48 are in the form of a shaft extending in the up-down direction, which is perpendicular to the extending direction of the arm-like locking piece 43, and connect the base end portion 44 of the arm-like locking piece 43 and the plate-shaped main body portion 31 of the slider 30. The arm-like locking piece 43 can tilt in the width direction that increases or decreases the areas of the portions of the abutment portion 45 and the stopper 16 that face each other, while twisting and deforming the support portions 48. Since the support portions 48 are in the form of an elongated shaft, stress generated in the support portions 48 is minimized even when the tilting angle of the arm-like locking piece 43 is increased to increase the areas of the portions of the abutment portion 45 and the stopper 16 that face each other. Since the support portions 48 have a circular cross-sectional shape, stress can be effectively dispersed when the support portions 48 are twisted and deformed.

The slider 30 has the movement restriction surfaces 40 that face the support portions 48 in the front-rear direction, which is parallel to the extending direction of the arm-like locking piece 43. When the support portions 48 are elastically deformed so as to tilt their axes in the front-rear direction, the amount of deformation of the support portions 48 can be suppressed by the support portions 48 coming into contact with the movement restriction surfaces 40.

The retaining portion 42 includes the releasing extension portion 49 extending from the base end portion 44 of the arm-like locking piece 43 in the direction (rearward) opposite to the abutment portion 45. The second housing 61 has the retention release portion 65. The retention release portion 65 interferes with the releasing extension portion 49 as the cam followers 64 of the second housing 61 are fitted into the cam grooves 33 of the slider 30. The interference of the retention release portion 65 with the releasing extension portion 49 while the abutment portion 45 is facing the stopper 16 causes the retaining portion 42 to tilt and the abutment portion 45 to displace to a position where it does not face the stopper 16. When the second housing 61 (cam followers 64) and the slider 30 (cam grooves 33) are fitted to each other while the slider 30 is retained at the fitting start position by the retaining portion 42, the retention by the retaining portion 42 is released due to the interference between the retention release portion 65 and the releasing extension portion 49. Therefore, manual operation to release the retention is not necessary.

In the front-rear direction, the separation distance S from the support portions 48 to the position of interference (the pressure receiving surface 50) of the releasing extension portion 49 with the retention release portion 65 is smaller than the separation distance L from the support portions 48 to the abutment portion 45. With this configuration, at the time of release of the retention, the amount of displacement of the abutment portion 45 is larger than the amount of displacement of the releasing extension portion 49, and this can ensure that the areas of the portions of the abutment portion 45 and the stopper 16 that face each other are large.

The first housing 11 has the tilt restriction surface 17, which faces the abutment portion 45 from the opposite side to the direction of displacement of the abutment portion 45 caused by the interference between the retention release portion 65 and the releasing extension portion 49. With this configuration, even when the abutment portion 45 pressed against the stopper 16 slips against the stopper 16, the abutment portion 45 can be kept in the state of abutting against the stopper 16.

### Other Embodiments

The present invention is not limited to the embodiment that has been described above using the drawings, but is indicated by the claims. The invention is intended to include all changes that come within the meaning of equivalency of the claims or within the scope of the claims, as well as embodiments described below.

In Embodiment 1 above, the buckling restriction portions are formed in the slider as with the arm-like locking piece. However, the buckling restriction portions may be formed in the first housing or the lever.

In Embodiment 1 above, the arm-like locking piece is formed in the slider. However, the arm-shaped locking piece may be formed in the lever or the first housing. When the arm-like locking piece is formed in the lever, the buckling restriction portions may be formed in any of the lever, the first housing, and the slider. When the arm-like locking piece is formed in the first housing, the buckling restriction portions may be formed in any of the first housing, the lever, and the slider.

In Embodiment 1 above, the boosting function member is composed of two parts: the lever and the sliders. However, the boosting function member may be composed of only the lever or only the sliders.

In Embodiment 1 above, the buckling restricting portions are disposed so as to face the abutment portion from the support portion side. However, the buckling restriction portions may be disposed so as to face the arm-like locking piece in the tilting direction of the arm-like locking piece.

In Embodiment 1 above, the support portions are in the form of a shaft. However, the support portions may have a shape other than the shape of a shaft.

In Embodiment 1 above, the support portions have a circular cross-sectional shape. However, the cross-sectional shape of the support portions may be an ellipse, an oval, a triangle, a square, or the like.

### List of Reference Numerals

10 First connector
11 First housing
12 Housing main body
13 Wire cover
14 Guide space
15 Outer wall portion
16 Stopper
17 Tilt restriction surface
18 Shaft portion
20 Lever (Boosting function member)
21 Operating portion
22 Arm portion
23 Bearing hole
24 Gear
30 Slider (Boosting function member)
31 Plate-shaped main body portion
31G Outer surface of plate-shaped main body portion
31N Inner surface of plate-shaped main body portion
32 Rack
33 Cam groove
33E Inlet of cam groove
35 Accommodation space
36 First groove
37 Recess
38 Second groove
39 Buckling restriction portion
40 Movement restriction surface
42 Retaining portion
43 Arm-like locking piece
44 Base end portion
45 Abutment portion
46 Widened portion
48 Support portion
49 Releasing extension portion
50 Pressure receiving surface (Position of interference of releasing extension portion with retention release portion)
51 Interference avoidance groove
52 Locking portion
60 Second connector
61 Second housing
62 Terminal main body portion
63 Hood portion
64 Cam follower
65 Retention release portion
L Separation distance from support portion to position of interference of releasing extension portion with retention release portion
S Separation distance from support portion to abutment portion

1. A connector comprising:
a first housing;
a second housing configured to be fitted to the first housing;
a boosting function member provided in the first housing and configured to be displaced from a fitting start position to a fitting completion position relative to the first housing, thereby fitting the first housing and the second housing to each other;
a retaining portion formed in one member of the boosting function member and the first housing, the retaining portion including an arm-like locking piece extending in a cantilevered manner in a direction identical to a direction of displacement of the one member during the relative displacement of the boosting function member from the fitting start position to the fitting completion position;
a stopper formed in the other member of the boosting function member and the first housing and configured to restrict the boosting function member at the fitting start position from moving to the fitting completion position, by an abutment portion at an extended end portion of the arm-like locking piece abutting against the stopper in a direction identical to an extending direction of the arm-like locking piece; and
a buckling restriction portion provided in the boosting function member or the first housing and configured to restrict buckling of the arm-like locking piece.

2. The connector according to claim 1,
wherein the buckling restriction portion is disposed on an opposite side of the abutment portion from the stopper.

3. The connector according to claim 2,
wherein the retaining portion has a support portion in the form of a shaft extending in a direction perpendicular to the extending direction of the arm-like locking piece, the support portion connecting a base end portion of the arm-like locking piece and the one member, and
the arm-like locking piece is configured to tilt in a direction that increases or decreases areas of portions of the abutment portion and the stopper that face each other, while twisting and deforming the support portion.

4. The connector according to claim 3,
wherein the support portion has a circular cross-sectional shape.

5. The connector according to claim 3, comprising:
a movement restriction surface that faces the support portion in a direction parallel to the extending direction of the arm-like locking piece.

6. The connector according to claim 3,
wherein the retaining portion has a releasing extension portion extending from the base end portion of the arm-like locking piece in a direction opposite to the abutment portion,
the second housing has a retention release portion configured to interfere with the releasing extension portion as the second housing is fitted to the boosting function member, and
interference of the retention release portion with the releasing extension portion while the abutment portion is facing the stopper causes the retaining portion to tilt and the abutment portion to displace to a position where the abutment portion does not face the stopper.

7. The connector according to claim 6,
wherein a separation distance from the support portion to a position of interference of the releasing extension portion with the retention release portion is smaller than a separation distance from the support portion to the abutment portion.

8. The connector according to claim 6,
wherein the other member has a tilt restriction surface that faces the abutment portion from a side that is opposite to a direction of displacement of the abutment portion caused by interference between the retention release portion and the releasing extension portion.
